(19) United States
(12) Patent Application Publication
(10) Pub. No.: US 2014/0310870 A1
(43) Pub. Date: Oct. 23, 2014

(54) MULTI-FUNCTIONAL HOSPITAL BASSINET

(71) Applicant: Tekna, Inc., Kalamazoo, MI (US)

(72) Inventors: Matthew Gregory Czach, Kalamazoo, MI (US); Bryce Kelly Porter, Grand Rapids, MI (US)

(73) Assignee: Tekna, Inc., Kalamazoo, MI (US)

(21) Appl. No.: 14/256,013

(22) Filed: Apr. 18, 2014

Related U.S. Application Data
(60) Provisional application No. 61/813,450, filed on Apr. 18, 2013.

(51) Int. Cl. A47D 9/00; A61G 7/012; A61G 7/00

(52) U.S. Cl. CPC A47D 9/00; A61G 7/0015; A61G 7/012
USPC 5/11

(57) ABSTRACT

A mobile hospital bassinet includes a lower platform having a plurality of wheels and an upper platform. A plurality of vertically-operable legs connects the upper platform to the lower platform. A control is in operable communication with the plurality of vertically-operable legs, wherein the control is configured to dispose the vertically-operable platform in a position relative to the lower platform. An infant basket is coupled with the upper platform, wherein a tilting mechanism is coupled to the upper platform and the infant basket to dispose the infant basket between a plurality of angles relative to the upper platform. A plurality of compartments of the infant basket is defined by an interior surface of the infant basket. A cabinet assembly coupled to an underside of the upper platform.

### CROSS-REFERENCE TO RELATED APPLICATION

This application claims priority to and the benefit under 35 U.S.C. §119(e) of U.S. Provisional Patent Application No. 61/813,450, filed on Apr. 18, 2013, entitled “MULTI-FUNCTIONAL HOSPITAL BASSINET,” the entire disclosure of which is hereby incorporated herein by reference.

### FIELD OF THE INVENTION

The invention is in the field of mobile hospital bassinets, more specifically, mobile hospital bassinets that have multi-functional operability.

### SUMMARY OF THE INVENTION

In one aspect, a mobile hospital bassinet includes a vertically-operable platform movable between a first position and a second position, wherein the first position is below the second position. Also included is an operable infant basket coupled with the vertically-operable platform and operable between a first angle and a second angle relative to the vertically-operable platform, wherein the first angle is greater than the second angle. The mobile hospital bassinet also includes a cabinet assembly coupled to an underside of the vertically-operable platform, at least one drawer disposed in the cabinet assembly, and wherein an interior of the at least one drawer is accessible from first and second sides of the cabinet assembly.

In another aspect a mobile hospital bassinet includes a lower platform including a plurality of wheels, an upper platform, and a plurality of vertically operable legs that connect the upper platform to the lower platform and configured to dispose the upper platform in a plurality of positions relative to the lower platform. A control is included, wherein the control is in operable communication with the plurality of vertically operable legs, and wherein the control is configured to dispose the vertically-operable platform in a position relative to the lower platform. The mobile hospital bassinet also includes an infant basket coupled with the upper platform. A tilting mechanism is coupled to the upper platform and the infant basket and is configured to dispose the infant basket between a plurality of angles relative to the upper platform. The infant basket includes a plurality of compartments that are defined by an interior surface of the infant basket.

In yet another aspect, a multi-function hospital bassinet includes a vertically-operable platform movable between a first position and a second position, wherein the first position is below the second position. An operable infant basket is coupled with the vertically-operable platform and is operable between a first angle and a second angle relative to the vertically-operable platform, wherein the first angle is greater than the second angle. The infant basket includes a plurality of compartments that are defined by an interior surface of the infant basket. The multi-function hospital bassinet also includes a cabinet assembly coupled to an underside of the upper platform and at least one drawer is disposed in the cabinet assembly, wherein an interior of the at least one drawer is accessible from first and second sides of the cabinet assembly. Also included is at least one retractable platform, wherein each at least one retractable platform is disposed within a receptacle defined within the vertically-operable platform, and wherein each at least one retractable platform is operable between an extended position and a stowed position.

Still another aspect of the present invention includes a multi-functional bassinet that includes height adjustment to for ease of use by users interacting with the bassinet at different heights. The bassinet includes a basket with a tiltable feature that allows the head of an infant to positioned above the body or feet of the infant. The bassinet includes drawers that are accessible from at least two sides of the bassinet and at least one retractable platform, wherein the at least one retractable platform is moveable between an extended position and a stowed position. The bassinet provides a versatile, safe environment for an infant and includes many features designed to aid in the care of the infant.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a first top-side perspective view of one embodiment of the multi-functional hospital bassinet with the infant basket disposed at the lower second angle, the vertically operable platform in the lower first position, and the retractable work surface in the retracted closed position;

FIG. 2 is a second top-side perspective view of the multi-functional hospital bassinet of the FIG. 1;

FIG. 3 is the multi-functional hospital bassinet of FIG. 1 with the infant basket in the raised first angle, the vertically operable platform in the raised second position and the retractable work surface in an extended position;

FIG. 4 is a top-side perspective view of the multi-functional hospital bassinet of FIG. 3;

FIG. 5 is a first side elevational view of the multi-functional hospital bassinet of FIG. 1;

FIG. 6 is a second elevational view of the multi-functional hospital bassinet of FIG. 1;

FIG. 7 is a cross-sectional view of the multi-functional hospital bassinet of FIG. 5 taken along line VII-VII;

FIG. 8 is a cross-sectional view of the multi-functional hospital bassinet of FIG. 6 taken along line VIII-VIII;

FIG. 9 is a first side elevational view of the multi-functional hospital bassinet of FIG. 3;

FIG. 10 is a second side elevational view of the multi-functional hospital bassinet of FIG. 3;

FIG. 11 is a cross-sectional view of the multi-functional hospital bassinet of FIG. 9 taken along line XI-XI;

FIG. 12 is a cross-sectional view of the multi-functional hospital bassinet of FIG. 10 taken along line XII-XII; and

FIG. 13 is a top-side perspective view of an alternate embodiment of the multi-functional hospital bassinet.

### DETAILED DESCRIPTION

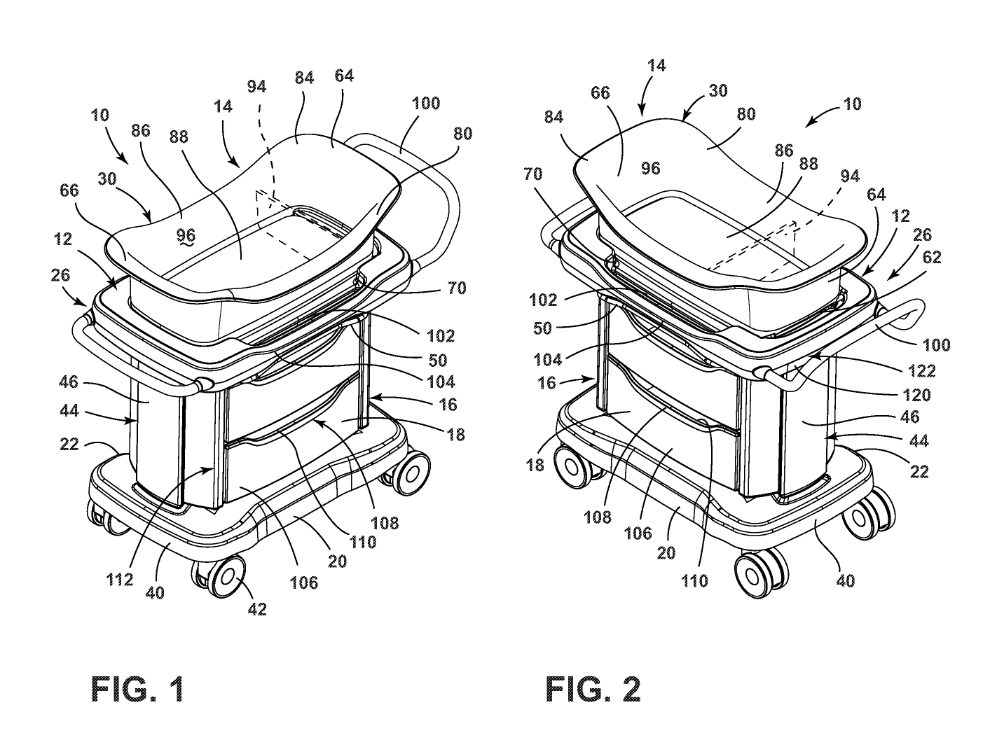

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

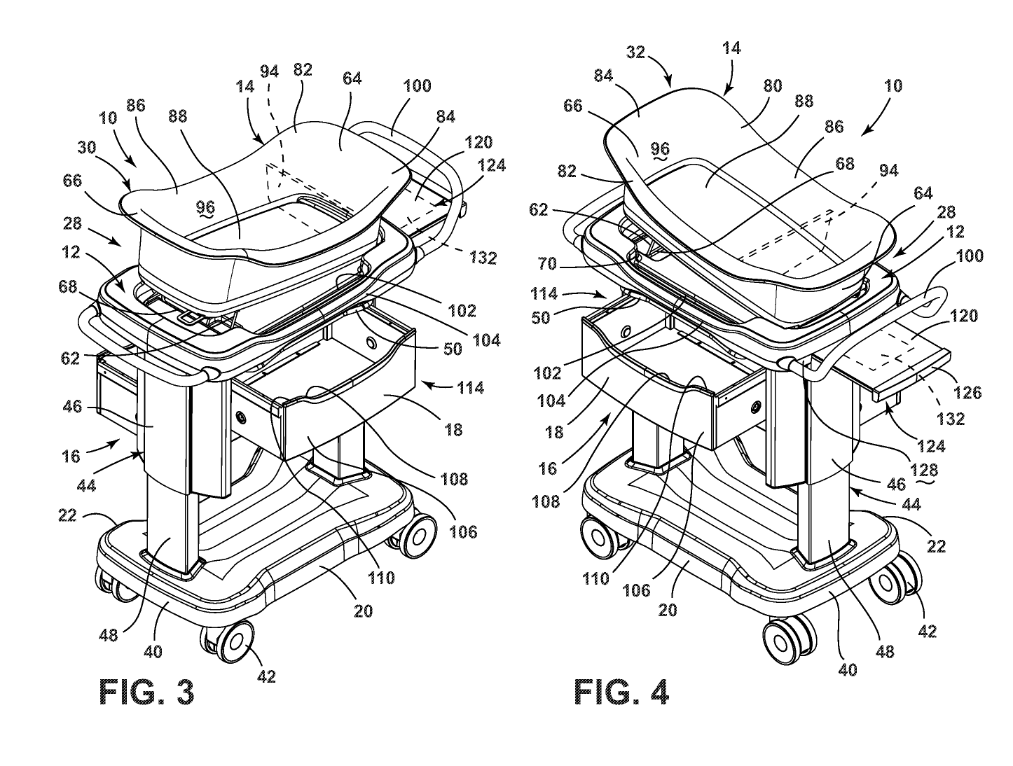

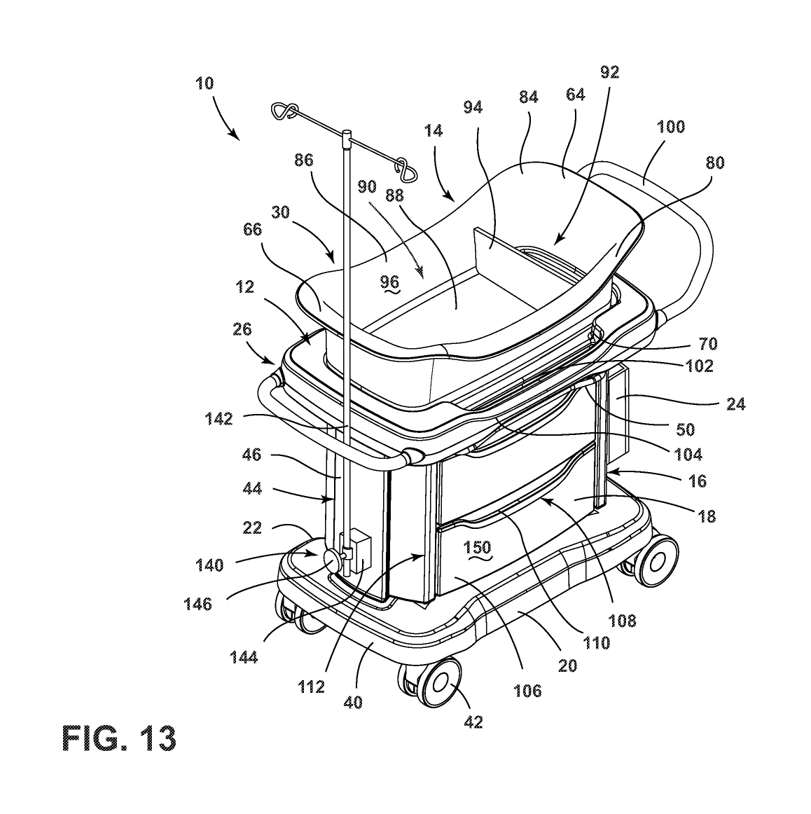

As illustrated in FIGS. 1-4, the reference number 10 generally refers to a multi-functional hospital bassinet 10 that includes a vertically-operable platform 12 movable between a first position 26 and a second position 28, wherein the first position 26 is below the second position 28. An operable infant basket 14 is coupled with the vertically-operable platform 12 and the operable infant basket 14 is movable between a first angle 30 and a second angle 32 relative to the vertically-operable platform 12, wherein the first angle 30 is greater than the second angle 32. A cabinet assembly 16 is coupled to an underside of the vertically-operable platform 12 and includes at least one drawer 18 disposed therein, wherein an interior of the at least one drawer 18 is accessible from first or second sides 20, 22 of the cabinet assembly 16. A document holder 24 (shown in FIG. 13) is also disposed on an exterior surface of the multi-functional hospital bassinet 10.

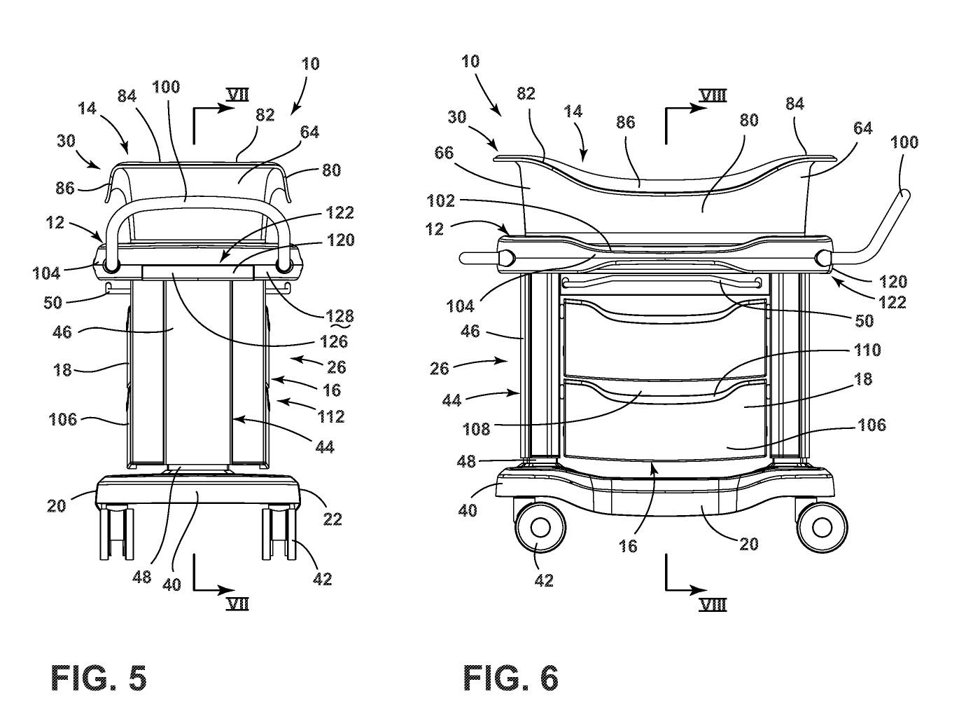

Referring now to the embodiment of FIGS. 5-8, the multi-functional hospital bassinet 10 can also include a lower platform 40 that includes a plurality of wheels or castors 42 on the underside of the lower platform 40 to enable a user to push, pull or otherwise maneuver the multi-functional hospital bassinet 10 from one location to another. A plurality of vertically operable legs 44 can be disposed on the multi-functional hospital bassinet 10 to connect the upper vertically-operable platform 12 to the lower platform 40. The vertically operable legs 44 are configured to dispose the vertically-operable platform 12 the first and second positions 26, 28 relative to the lower platform 40. In this manner, the height of the vertically- operable platform 12 is adjustable to accommodate users of varying heights and accommodate various tasks that can be performed more efficiently at differing or varying heights.

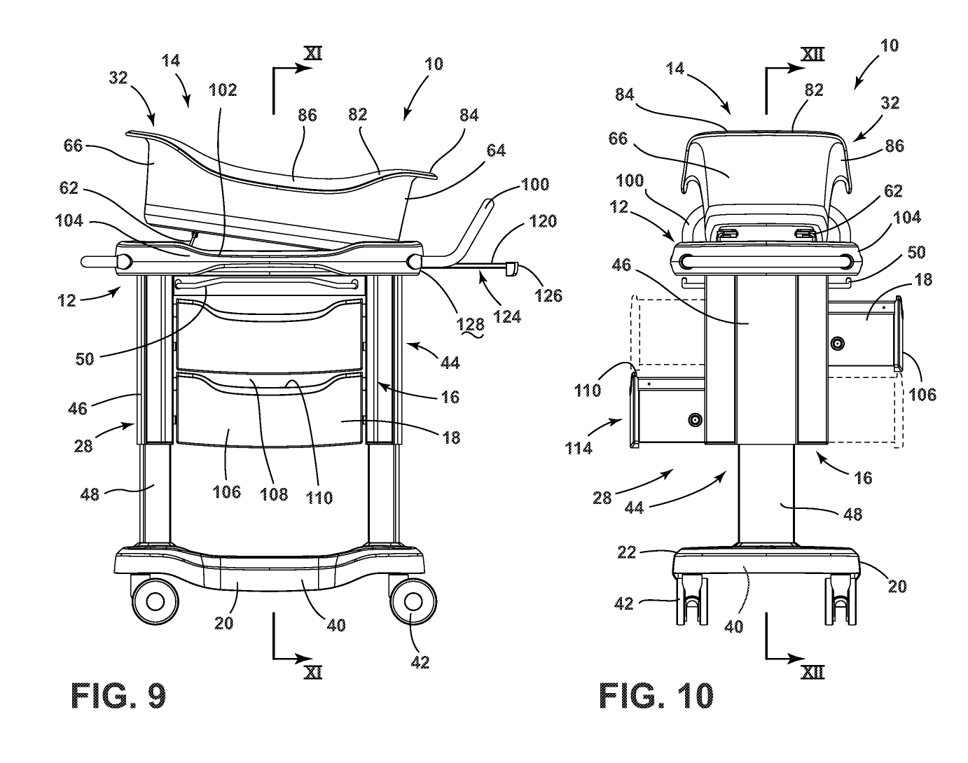

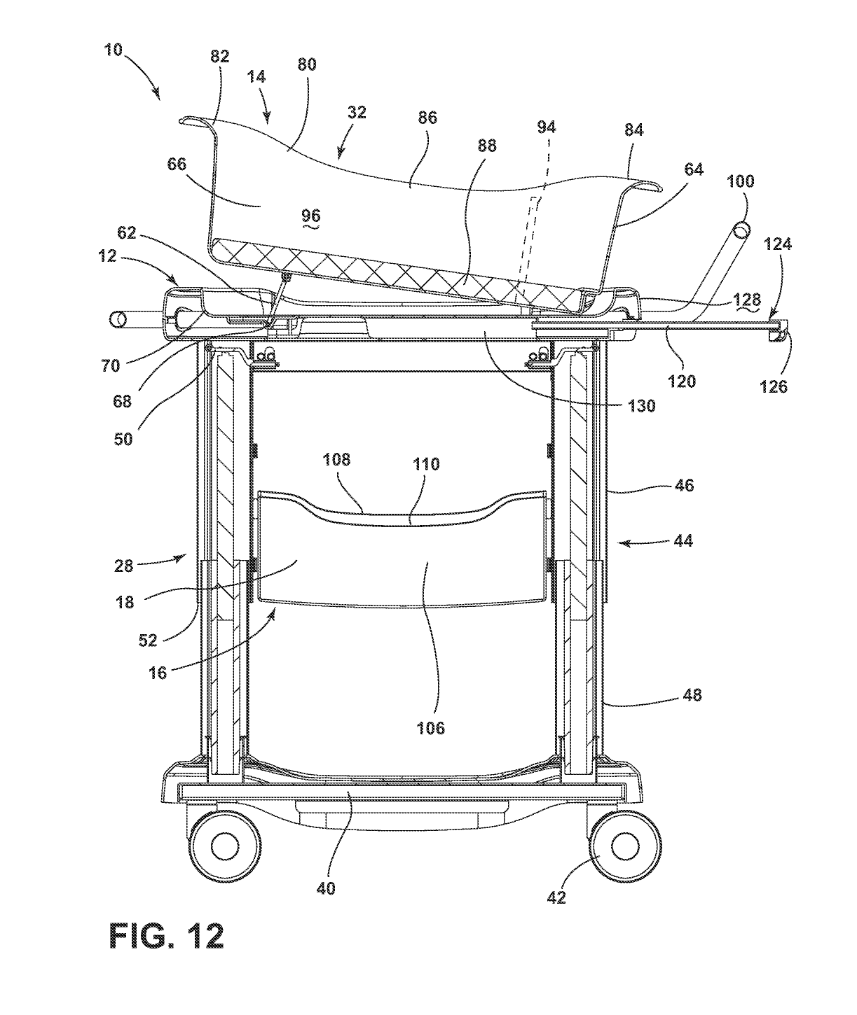

With reference to the embodiment depicted in FIGS. 1-12, the multi-functional hospital bassinet 10 includes at least one vertically operable leg 44. It should be understood that the multi-functional hospital bassinet 10 can also include a single vertically operable leg 44 or two or more vertically operable legs 44. The vertically operable leg 44 includes an upper member 46 having at least one opening 52 and a lower member 48 that is configured to be received by the opening 52 of the upper member 46. The upper member 46 is coupled with the vertically-operable platform 12 and the lower member 48 is coupled with the lower platform 40. In this manner, the lower member 48 slideably engages the upper member 46 such that the vertically operable leg 44 can be extended and retracted to raise and lower the vertically-operable platform 12 between the first and second positions 26, 28. In alternate embodiments, each of the vertically operable legs 44 can include adjacent sliding members, or can include additional telescoping members. The movement of the vertically operable legs 44 can be assisted by various mechanisms that can include, but are not limited to, a pneumatic mechanism, a hydraulic mechanism, a counterweighted mechanism, a motor driven mechanism, or other type of mechanism that can assist in the vertical movement of the vertically-operable platform 12 of the multi-functional hospital bassinet 10.

As illustrated in the embodiment of FIGS. 1-12, the vertically-operable platform 12 and the lower platform 40 can be made of various rigid materials that can include, but are not limited to, metal, plastic, composite, combinations thereof, or another substantially rigid material. The vertically operable legs 44 can be made of materials that can include, but are not limited to, metal, plastic, or other substantially rigid material that can cooperate with a device for raising and lowering the vertically-operable platform 12.

Referring again to the embodiment of FIGS. 1-12, in various the embodiments disclosed herein, a control 50 can be included in the multi-functional hospital bassinet 10 to operate the vertically operable legs 44 to raise and lower the vertically-operable platform of the multi-functional hospital bassinet 10. The control 50 can include, but is not limited to, levers, switches, release bars, electrical or digital controls, or other types of controls that can be used to engage and disengage a mechanism for raising and lowering the vertically-operable platform 12 of the multi-functional hospital bassinet 10. In various embodiments, it may be necessary for the user to push or pull the vertically-operable platform 12 in conjunction with operating the control 50 in order to operate the vertically-operable platform 12, such as where the control 50 is a lever, button, switch, release bar or other similar control. In alternate embodiments, minimal effort may be necessary on the part of the user other than engaging or disengaging the control 50, such as where the control 50 and the operating mechanism are at least partially automated, such as when the control 50 is digital or electrical and the operating mechanism is hydraulic, pneumatic, or motorized.

As illustrated in the embodiment of FIGS. 1-12, the multi-functional hospital bassinet 10 includes an infant basket 14 that is disposed on the vertically-operable platform 12. The infant basket 14 is configured with a tilting mechanism 62 disposed at a first end 64 of the infant basket 14 configured to allow a user to raise and lower a second end 66 of the infant basket 14 between the first and second angles 30, 32 relative to the vertically-operable platform 12. To assist the user in tilting the infant basket 14, the tilting mechanism 62 can include a pneumatic system, a hydraulic system, a motor driven system, or other system that can assist the user in raising and lowering the infant basket 14 to a plurality of angles relative to the vertically-operable platform 12. The tilting mechanism 62 also includes a locking feature 68 that can be engaged to secure the infant basket 14 at a particular angle relative to the vertically-operable platform 12, and then be disengaged to allow the infant basket 14 to be adjusted to another angle or lowered back to a rest position substantially parallel with the vertically-operable platform 12. The locking feature 68 can include, but is not limited to, pins, latches, clasps, gear-locking mechanisms, stands, or other implements that can be used to substantially secure the infant basket 14 at an angle relative to the vertically-operable platform 12. The tilting mechanism 62 can be fixedly coupled with the vertically-operable platform 12 and releasably coupled with the infant basket 14 to allow the infant basket 14 to be removed for cleaning or replacement. In alternate embodiments, one portion of the tilting mechanism 62 can be coupled to the vertically-operable platform 12 and another portion of the tilting mechanism 62 can be coupled with the infant basket 14, such that the two portions of the tilting mechanism 62 can be coupled together to form the tilting mechanism 62. In still other alternate embodiments, the vertically-operable platform 12, the tilting mechanism 62, and the infant basket 14 are separate parts, wherein the tilting mechanism 62 can be coupled to the vertically-operable platform 12 and the infant basket 14.

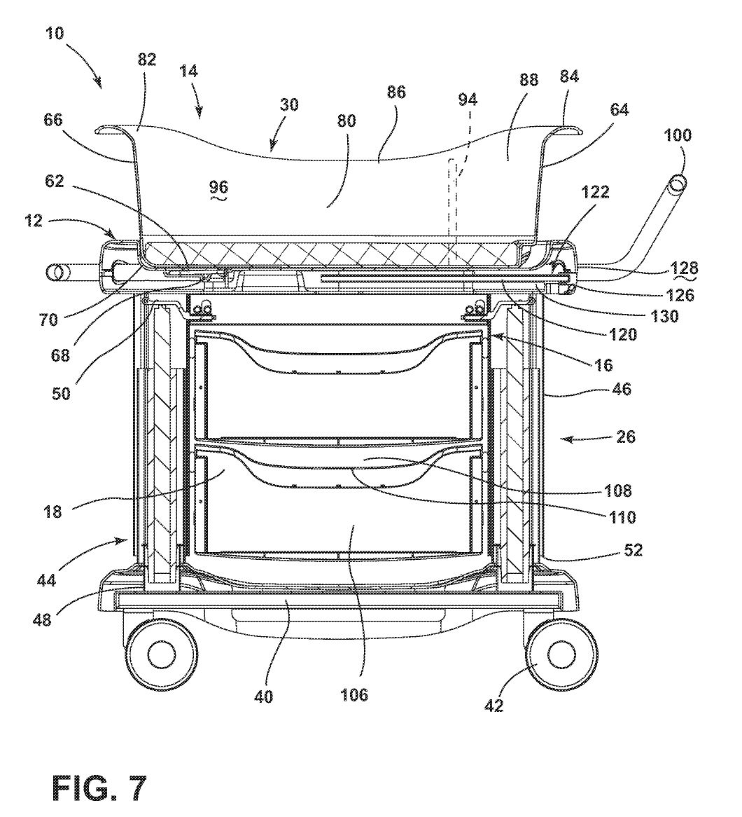

Referring again to the embodiment of FIGS. 7-8 and 11-12, the vertically-operable platform 12 can include a depression 70 or opening defined in the top surface of the vertically-operable platform 12 that is configured to receive the infant basket 14 and the tilting mechanism 62. In such an embodiment, the depression 70 can provide additional lateral support to the infant basket 14 and place the infant basket 14 at a lower height in relation to the vertically-operable platform 12, thereby making the infant basket 14 more secure and more accessible.

As illustrated in the embodiment of FIGS. 1-12, the infant basket 14 is made of an at least partially translucent material that can include plastic, acrylic, glass, or other at least partially translucent material. In alternate embodiments, the infant basket 14 is made of an opaque material that can include, but is not limited to, plastic, acrylic, composite material, or other substantially rigid and opaque material. The infant basket 14 includes a perimetrical wall 80 that includes a rim 82 having raised portions 86 at the first and second ends 64, 66 of the infant basket 14 and lowered portions 84 that are distal from the first and second ends 64, 66. The lowered portions 84 distal from the first and second ends 64, 66 are configured to allow the user easier access to the interior of the infant basket 14, while still providing adequate support for the infant placed inside the infant basket 14. As shown in FIGS. 7-8 and 11-12, a mattress 88 can be placed inside the infant basket 14 to provide increased comfort and support to the infant placed within the infant basket 14.

Referring now to the embodiment illustrated in FIG. 13, the infant basket 14 can include a primary compartment 90 for placing the infant within the infant basket 14, as well as a smaller secondary compartment 92 adjacent to the primary compartment 90. The secondary compartment 92 can be used to place various items that can include, but are not limited to, medical devices, such as thermometers, aspirators, stethoscopes, tongue depressors, and the like, as well as infant needs such as diapers, towels, toys, and the like. The primary compartment 90 and secondary compartment 92 can be divided by an interior wall 94 which separates items contained within the secondary compartment 92 from an infant located in the primary compartment 90. In the various embodiments, an interior surface 96 of the infant basket 14 defines a plurality of compartments of the infant basket, including the primary and secondary compartments 90, 92. In this manner, items that are convenient to have proximate the infant, but which can cause injury to the infant, are kept in an area separated from the infant. It should be understood that additional compartments can be placed within the infant basket 14 based upon the various needs of the user. In addition, in various embodiments, the interior wall 94 can be removable such that the secondary compartment 92 is eliminated and only the primary compartment 90 is included within the infant basket 14. In other alternate embodiments, the interior wall 94 can be movable between a plurality of positions to increase the size of the secondary compartment 92 while decreasing the size of the primary compartment 90, or vice versa, based upon the needs of a user and the individual infant located within the infant basket 14.

Referring again to the embodiment of FIGS. 1-12, the vertically-operable platform 12 can include at least one contoured handle 100 for the user to push, pull or otherwise maneuver the multi-functional hospital bassinet 10 from one location to another. The contoured handles 100 can be made of substantially rigid materials that can include, but are not limited to, metal, plastic, composite material, a combination thereof, or other substantially rigid material.

In the various embodiments, the contoured handle 100 can be formed into various shapes that can include various orthogonal and arcuate geometries. It is contemplated that two contoured handles 100 can be included on either end of the vertically-operable platform 12. Alternatively, various embodiments can include two identical contoured handles 100 on either side of the vertically-operable platform 12, or two dissimilar contoured handles 100 disposed at the two ends of the vertically-operable platform 12.

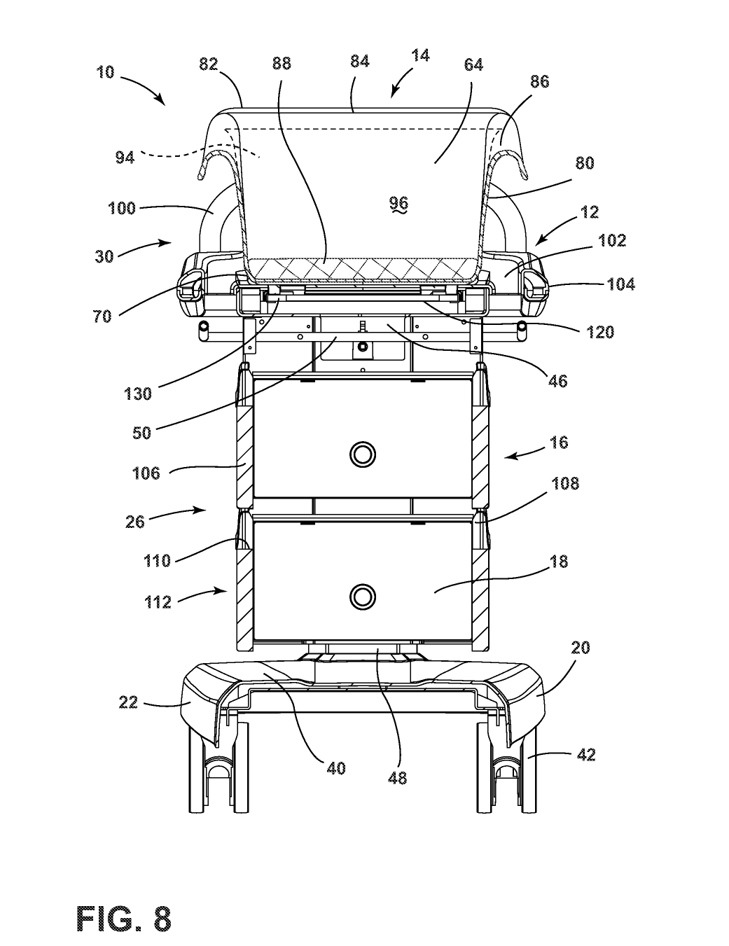

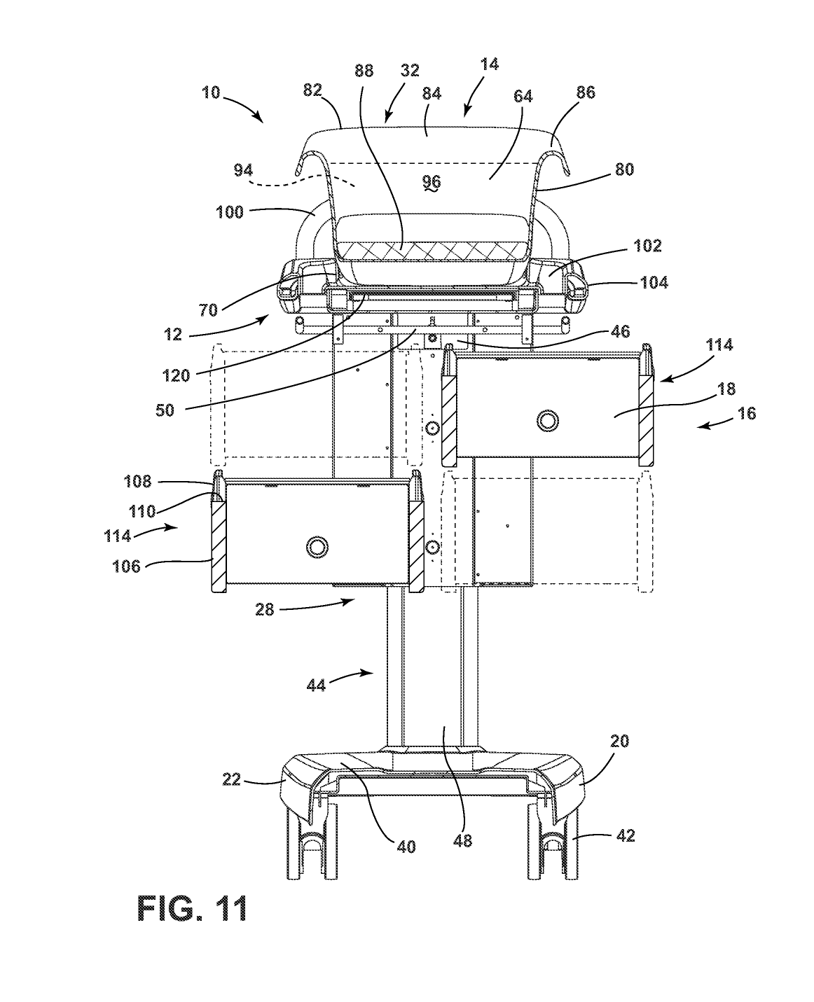

As illustrated in the embodiment of FIGS. 8 and 11, the vertically-operable platform 12 can include at least one recessed portion 102 proximate a lateral edge 104 of the vertically-operable platform 12 that can be used as a handle to further maneuver the multi-functional hospital bassinet 10. Additional recessed portions 102 can be included within the surface of the vertically-operable platform 12 such that one recessed portion 102 is disposed proximate each lateral edge 104 of the vertically-operable platform 12. Additional recessed portions 102 can also be included within the surface of the vertically-operable platform 12 that can also be used as containers for various items that can include medical devices and infant related items. It is contemplated that the recessed portion can be an opening in the vertically-operable platform 12.

Referring again to the embodiment of FIGS. 1-12, the illustrated embodiment includes the cabinet assembly 16 disposed on the underside of the vertically-operable platform 12 such that when the vertically-operable platform 12 is moved up and down, the cabinet assembly 16 moves with the vertically-operable platform 12. The cabinet assembly 16 can include one or more drawers 18 that can be pulled open from opposite ends such that the interiors of each of the drawers 18 can be accessed from first and second sides 20, 22 of the cabinet assembly 16. In this manner, either the first or second sides 20, 22 of the cabinet assembly 16 can be placed adjacent to a wall or bed and the drawers 18 of the cabinet assembly 16 can be accessed from the opposing second or first side 22, 20 respectively. In alternate embodiments, the cabinet assembly 16 of the multi-functional hospital bassinet 10 can include cabinet doors, retractable workspaces, clips, hooks, interior drawers, or a combination thereof.

As shown in FIGS. 1-12, the drawers 18 of the cabinet assembly 16 include end panels 106 each having a cutout 108 defined by the top edge 110 of the end panel 106, where the cutout 108 can be used as a handle to pull the drawer 18 out from the cabinet assembly 16. In alternate embodiments, handles, knobs, or other grasping mechanisms can be used to open and close each of the drawers 18 of the cabinet assembly 16. In various embodiments, the drawers 18 can also include drawer slides that have a soft-close feature, such that the drawers 18 cannot be forceably closed. In various embodiments, the drawers 18 can include a biasing mechanism such that the drawer 18 is biased towards a closed position 112 regardless of which side 20, 22 of the cabinet assembly 16 that the drawer 18 is opened from. In still other embodiments, each of the drawers 18 can also include a stop, latch or catch that can keep the drawer 18 from moving to an open position 114, such as when the multi-functional hospital bassinet 10 is in transit or when it is desirable for the drawers 18 to remain in the closed position 112 to substantially prevent access to the drawers 18 by unauthorized persons such as children, non-hospital staff or other unauthorized individuals.

In the various embodiments, the cabinet assembly 16 and two-way drawers 18 of the cabinet assembly 16 can be made of various rigid materials that can include, but are not limited to, wood, plastic, metal, composite material, a combination thereof, or other rigid material.

Referring again to FIGS. 1-12, the castors 42 located on the underside of the lower platform 40 can be configured to rotate to allow for the maneuverability of the multi-functional hospital bassinet 10. In addition, one or more of the castors 42 can include a locking mechanism to substantially prevent the movement of the multi-functional hospital bassinet 10 when the castors 42 are placed in the locked position. In various embodiments, at least a portion of the castors 42 may be configured to rotate to allow the multi-functional hospital bassinet 10 to turn in a substantially controlled manner. Further, in various embodiments, each of the castors 42 can include a plurality of wheels, or, in alternate embodiments, each castor can have a single wheel, or in yet other alternate embodiments, the castors 42 can be equipped with a combination of single wheel castors 42 and multi-wheel castors 42.

Referring now to the embodiment of FIGS. 2-4, 7-9 and 11-12, as illustrated in the embodiment, the multi-functional hospital bassinet 10 can include one or more retractable work surfaces 120 disposed within the vertically-operable platform 12. Each of the retractable work surfaces 120 can be disposed in retracted and extended positions 122, 124. When the retractable work surface 120 is in the retracted position 122, an outer edge 126 of the retractable work surface 120 is substantially even with an outer surface 128 of the vertically-operable platform 12. Alternatively, when any one or more of the retractable work surfaces 120 are in the extended position 124, the retractable work surface 120 provides an additional surface area of the multi-functional hospital bassinet 10 upon which various items can be placed, such as charts, medical devices, infant related items, note-taking devices, or other items related to the care or comfort of the infant. In various embodiments, the vertically-operable platform 12 can include two retractable work surfaces 120 disposed at ends of the vertically-operable platform 12 adjacent to each of the contoured handles 100. In alternate embodiments, additional retractable work surfaces 120 can be included in the vertically-operable platform 12 adjacent to the lateral edges 104 of the vertically-operable platform 12, or in other locations of the vertically-operable platform 12. The retractable work surfaces 120 can be made of various materials that can include, but are not limited to, metal, plastic, composite material, or other substantially rigid material. Cavities 130 defined within the vertically-operable platform 12 are configured to receive the retractable work surfaces 120. The cavities 130 for the retractable work surfaces 120 can include one or more channels or ridges that are configured to receive cooperating ridges or channels of the retractable work surface 120 to prevent unnecessary lateral movement of the retractable work surface 120. In addition, the retractable work surface 120 can include a stop mechanism to prevent the retractable work surface 120 from being completely removed from the cavity 130 defined by the vertically-operable platform 12. In still other alternate embodiments, the retractable work surface 120 can include one or more surface recesses 132 in to which items can be placed to substantially prevent items from rolling or sliding off of the retractable work surface 120. In other embodiments, the retractable work surface 120 can include openings into which cups, bowls, and other containers can be placed and substantially secured to the retractable work surface 120.

Referring again to the embodiment of FIG. 13, various accessories can be disposed on the outer surface 128 of the multi-functional hospital bassinet 10. These accessories can include an accessory mount 140 for securing a stanchion 142 to the multi-functional hospital bassinet 10, where the stanchion 142 is used to hold various medical related devices that can include, but are not limited to, IV bags, pumps, monitoring devices, and other medical equipment. The accessory mount 140 can include a bracket 144 having an aperture defined therein, into which the stanchion 142 can be placed. A tightening mechanism 146 can be disposed proximate the opening in the bracket 144 such that the tightening mechanism 146 can be engaged to secure the stanchion 142 to the accessory mount 140 at a predetermined height. The tightening mechanism 146 can be a threaded screw, a clamp, or other height adjusting mechanism. The multi-functional hospital bassinet 10 can also include various clips, hooks, or holders for securing charts or other documents related to the infant to the multi-functional hospital bassinet 10.

In the various embodiments, various alternate configurations of the multi-functional hospital bassinet 10 are contemplated. These various configurations can include vertical or contoured legs 44, and configurations having two or four legs 44. The cabinet assembly 16 can be configured to include one, two, or more drawers 18 that are accessible from at least two sides of the multi-functional hospital bassinet 10. Various embodiments of the multi-functional hospital bassinet 10 can also include one or two contoured handles 100 as well as various configurations of the infant basket 14 having a lower wall portion on at least one side of the perimetrical wall 80 of the infant basket 14.

Referring again to FIGS. 13, the illustrated embodiment of the multi-functional hospital bassinet 10 can include various indicia 150 located on the exterior surface of the cabinet assembly 16. In various embodiments, depending on the needs of the user, indicia 150 can be located on any exterior surface of the multi-functional hospital bassinet 10, where the indicia 150 can include various graphic patterns, words, logos, or other indicia 150 as predetermined by the user of the multi-functional hospital bassinet 10. In addition, various security features can be included on the multi-functional hospital bassinet 10 that can include, but are not limited to, name plates, tracking devices, global positioning system, or other position monitoring device, that can be used to match the particular multi-functional hospital bassinet 10 to the particular infant to which the multi-functional bassinet 10 has been assigned.

It will be understood by one having ordinary skill in the art that construction of the described application and other components is not limited to any specific material. Other exemplary embodiments of the application disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the application as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present application. The exemplary structures and processes disclosed herein are for illustrative purposes and are not to be construed as limiting.

It is also to be understood that variations and modifications can be made on the aforementioned structures and methods without departing from the concepts of the present application, and further it is to be understood that such concepts are intended to be covered by the following claims unless these claims by their language expressly state otherwise.

The above description is considered that of the illustrated embodiments only. Modifications of the application will occur to those skilled in the art and to those who make or use the application. Therefore, it is understood that the embodiments shown in the drawings and described above is merely for illustrative purposes and not intended to limit the scope of the application, which is defined by the following claims as interpreted according to the principles of patent law, including the Doctrine of Equivalents.

The invention claimed is:

1. A mobile hospital bassinet comprising:
a vertically-operable platform movable between a first position and a second position, wherein the first position is different than the second position;
an operable infant basket coupled with the vertically-operable platform and operable between a first angle and a second angle relative to the vertically-operable platform, wherein the first angle is greater than the second angle;
a cabinet assembly coupled to an underside of the vertically-operable platform; and
at least one drawer disposed in the cabinet assembly, wherein an interior of the at least one drawer is accessible from first and second sides of the cabinet assembly.

2. The mobile hospital bassinet of claim 1, further comprising:
a control in communication with the vertically-operable platform, wherein the control is adapted to selectively operate the vertically-operable platform between the first and second positions.

3. The mobile hospital bassinet of claim 1, further comprising:
a plurality of vertically operable legs that connect the vertically-operable platform to a lower platform and configured to dispose the vertically-operable platform in a plurality of positions relative to the lower platform.

4. The mobile hospital bassinet of claim 1, wherein the infant basket includes a plurality of compartments defined by an interior surface of the infant basket.

5. The mobile hospital bassinet of claim 4, wherein the plurality of compartments includes a primary compartment and a secondary compartment, and wherein the primary compartment is larger than the secondary compartment.

6. The mobile hospital bassinet of claim 1, further comprising:
at least one retractable platform, each at least one retractable platform disposed within a cavity defined within the vertically-operable platform, wherein each at least one retractable platform is operable between an extended position and a retracted position.

7. The mobile hospital bassinet of claim 1, further comprising:
a document receptacle disposed on an exterior surface of the mobile hospital bassinet.

8. The mobile hospital bassinet of claim 1, further comprising:
at least one stanchion mount coupled to an exterior surface of the mobile hospital bassinet.

9. A mobile hospital bassinet comprising:
a lower platform including a plurality of wheels;
an upper vertically-operable platform;
at least one vertically operable leg that connects the vertically-operable platform to the lower platform;
a control in operable communication with the at least one vertically operable leg, wherein the control is configured to dispose the vertically-operable platform in a plurality of positions relative to the lower platform;
an infant basket coupled with the vertically-operable platform, a plurality of compartments;
a tilting mechanism coupled to the vertically-operable platform and the infant basket and configured to dispose the infant basket between a plurality of angles relative to the vertically-operable platform; and
a cabinet assembly coupled to an underside of the vertically-operable platform.

10. The mobile hospital bassinet of claim 9, further comprising:
a document receptacle disposed on an exterior surface of the mobile hospital bassinet.

11. The mobile hospital bassinet of claim 9, further comprising:
at least one retractable platform, each at least one retractable platform disposed within a cavity defined within the vertically-operable platform, wherein each at least one retractable platform is operable between an extended position and a retracted position.

12. The mobile hospital bassinet of claim 9, wherein the plurality of compartments includes a primary compartment and a secondary compartment, and wherein the primary compartment is larger than the secondary compartment.

13. The mobile hospital bassinet of claim 9, wherein the cabinet assembly includes at least one drawer disposed in the cabinet assembly, wherein an interior of the at least one drawer is accessible from first and second sides of the cabinet assembly.

14. The mobile hospital bassinet of claim 9, further comprising:
at least one stanchion mount coupled to an exterior surface of the mobile hospital bassinet.

15. The mobile hospital bassinet of claim 9, wherein the at least one vertically operable leg includes an upper member and a lower member, wherein the upper and lower members slideably engage one another to define the plurality of positions of the vertically-operable platform.

16. A multi-function hospital bassinet comprising:
a vertically-operable platform movable between a first position and a second position, wherein the first position is below the second position;
an operable infant basket coupled with the vertically-operable platform and operable between a first angle and a second angle relative to the vertically-operable platform, wherein the first angle is greater than the second angle;
a plurality of compartments defined by an interior surface of the infant basket;
a cabinet assembly coupled to an underside of the vertically-operable platform;
at least one drawer disposed in the cabinet assembly, wherein an interior of the at least one drawer is accessible from first and second sides of the cabinet assembly; and
at least one retractable platform, each at least one retractable platform disposed within a receptacle defined within the vertically-operable platform, wherein each at least one retractable platform is operable between an extended position and a retracted position.

17. The multi-function hospital bassinet of claim 16, further comprising:
a plurality of vertically operable legs that connect the vertically-operable platform to a lower platform and configured to dispose the vertically-operable platform in a plurality of positions relative to the lower platform.

18. The multi-function hospital bassinet of claim 17, wherein each of the plurality of vertically operable legs includes an upper member and a lower member, wherein the upper and lower members slideably engage one another to define the plurality of positions of the vertically-operable platform.

19. The multi-function hospital bassinet of claim 16, wherein the infant basket includes a selectively operable interior wall that is operable between a plurality of positions to define the plurality of compartments of the infant basket, and wherein the infant basket includes a primary basket and a secondary basket, the primary basket being larger than the secondary basket.

20. The multi-function hospital bassinet of claim 16, further comprising:
at least one stanchion mount coupled to an exterior surface of the multi-functional hospital bassinet.
